(19) United States
(12) Patent Application Publication
(10) Pub. No.: US 2009/0252909 A1
(43) Pub. Date: Oct. 8, 2009

(54) Warm stretching processing for molding polyactic acid containers

(76) Inventor: Liang-An Wei, Taipei County (TW)

Correspondence Address: Wei Liang-An, P.O.Box 166-13, Taipei, 115, TW

(21) Appl. No.: 12/216,398

(22) Filed: Jul. 3, 2008

(30) Foreign Application Priority Data
Apr. 3, 2008 (TW) 097112109

(51) Int. Cl. B32B 1/08; B29C 51/06

(52) U.S. Cl. 428/36.9; 264/101

(57) ABSTRACT

The present invention is related to a warm stretching processing for molding polylactic acid containers, comprising: step 1, prefabricated PLA slips (10) or the like processed through a heater (20); step 2, a pre-heated mold (30) presses said initial warm stretchable PLA slips (10) through high-pressure under near-vacuum conditions and heated to 100° C. or more, said slips (10) turned into melt, warm stretching proceeded to shape a parison (11); and step 3, trim off fringe ends, a high-temperature endurable finished container (12) is formed.

### FIELD OF THE INVENTION

The present invention is related to warm stretching processing of molding polylactic acid containers.

### BACKGROUND OF THE INVENTION

As well-known, synthetic plastics usually tend to decompose slowly, because synthetic plastics are endowed with stable chemical and physical properties; such as polyethylene terethphalate (PET), nylon, acrylics, and polypropylene (PP). Other than the synthetic plastics synthesized from fossil petroleum, synthetic polymers of biofabric such as lactic acid produced through bacterial fermentation of corn starch or cane sugar further can be polymerized into biodegradable polylactic acid (PLA) of high molecular weight, whose melting point ranged from 90° C.˜to 200° C.; such as poly-L-lactide (PLLA) is the product resulting from polymerization of L,L-lactide (also known as L-lactide). PLLA has a crystallinity of around 37%, a glass transition temperature between 50-80° C. and a melting temperature between 173-178° C. Although it is still lower than PET, or nylon; but it is close to the melting point of PP. In addition, PLA is similar in heat resistance as well as fiber strength to Polyester fibers.

When finishing through a given temperature, operated under certain acidity or basicity of a solution (pH value) and a fixed ratio of water content, final PLA products assure quality control with sufficient stiffness, oil-proof, water-proof, and adhesive-proof. In the long run, PLA can be decomposed into water and carbon dioxide conforms to environmental protection standards. Obviously, PLA is not recognized as a petroleum based synthetic plastic, and not contributed to so-called fossil fuel regret for users.

Under such assumptions, offering containers made of polystyrene (PS, i.e. Styrofoam), polyethylene (PE), polypropylene (PP), polyvinyl chloride (PVC), and polyamine resin are all petroleum based synthetic plastics; in the long run, that the PLA containers or the like may be used instead of them. In comparison with so called petroleum based products, the PLA container, either filled with hot drink or hot meals, is to be relieved from dissipating into heat with dissolved plastic or benzene to ambient environment and edible foodstuffs.

Manufacturing of said PLA containers usually molded through heat processing in the range of 60° C.˜70° C., the containers easily deformed when encountered hot foodstuffs or liquid with a temperature higher than 70° C. For example, hot water heated up to 90° C.˜100° C. poured into said PLA containers soon will cause physical changes to distort the containers. But warm stretching PLA under 100° C. or above is capable of providing better heat resistance effect than the conventional PLA containers easily defected by retaining over heated food stuffs or the like.

Accordingly, PLA material molded and shaped through warm stretching available means and provided with finished PLA containers are concerned by the invention.

The present invention is to provide a warm stretching processing of molding polylactic acid (PLA) containers comprising:

Step 1, prefabricated PLA slips (10) or the like processed through a heater (20);

Step 2, a pre-heated mold (30) presses said initial warm stretching PLA slips (10) through high-pressure under near-vacuum conditions and heated to, at least, 100° C., said slips (10) proceeded to shape into a parison (11); and

step 3, trim off fringe ends, a high-temperature endurable finished container (12) is formed.

The warm stretching processing for molding polylactic acid (PLA) containers of claim 1 wherein heat-softing the slips (10) of step 1 under a temperature shift from 60° C. to 80° C.

The warm stretching processing for molding polylactic acid (PLA) containers of claim 1 wherein the heater (20) of step 1 is operated preferably under a temperature shift from 25° C. to 300° C.

The warm stretching processing for molding polylactic acid (PLA) containers of claim 1 wherein the mold (30) of step 2 is preheated under a temperature shift from 100° C. to 130° C., preferably operated under a temperature of 120° C.

The warm stretching processing for molding polylactic acid (PLA) containers of claim 1 wherein a breadth of the slips (10) of step 1 is in the range of 0.1 mm˜12 mm.

The warm stretching processing for molding polylactic acid (PLA) containers of claim 1 wherein a breadth of the slips (10) of step 1 is preferably in the range of 0.3 mm˜2 mm.

Molding polylactic acid (PLA) containers processed through high-temperature treatment as above; said finished containers (12) are achieved.

### ADVANTAGES OF EMBODIMENTS OF THE PRESENT INVENTION

By embodiments of the present invention, said finished container (12) is high-temperature endurable under a temperature shift from 100° C.˜130° C. In other words, heat-resistance effect to the container (12) is improved. Even the container (12) is filled with hot water of 100° C.; the container (12) will not be out of shape.

Next, heat-softing said slips (10) is processed through heat treatments of the heater (20), which is operated under a temperature shift from 250° C.˜300° C. Since the same is originally heat-soften under a temperature shift from 60° C.˜80° C., being processed through higher temperature shift may facilitate next step of processing to achieve finished containers.

Moreover, said mold (30) is preheated under a temperature shift from 100° C.˜130° C. Said slips (10) is pressed and heated up to a temperature of 100° C. or more under near vacuum conditions to warm-stretch the slips to shape a parison.

A breadth of said slip (10) is restricted in the range of 0.1 mm˜12 mm, preferably in the range of 0.3 mm˜2 mm. The latter is suitable for a finished container to show fashions.

### BRIEF DESCRIPTION OF THE DRAWINGS

FIG. 1: is a diagrammatic view of a flow diagram of warm stretching processing for molding polylactic acid (PLA) containers;

FIG. 2: is a schematic view of warm stretching processing for molding polylactic acid (PLA) containers; and

FIGS. 3˜9: are schematic views of warm stretching processing for molding polylactic acid (PLA) containers heated and pressed under near vacuum conditions.

### DETAILED DESCRIPTION OF THE PREFERRED EMBODIMENTS OF THE INVENTION

The description is described in detail according to the appended drawings hereinafter.

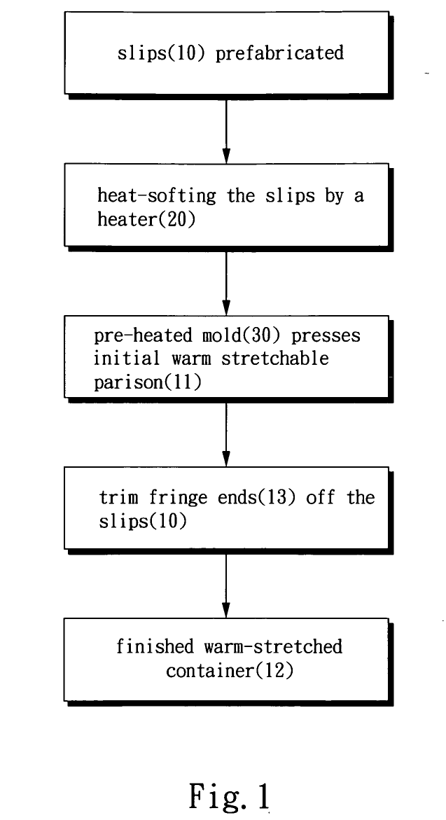

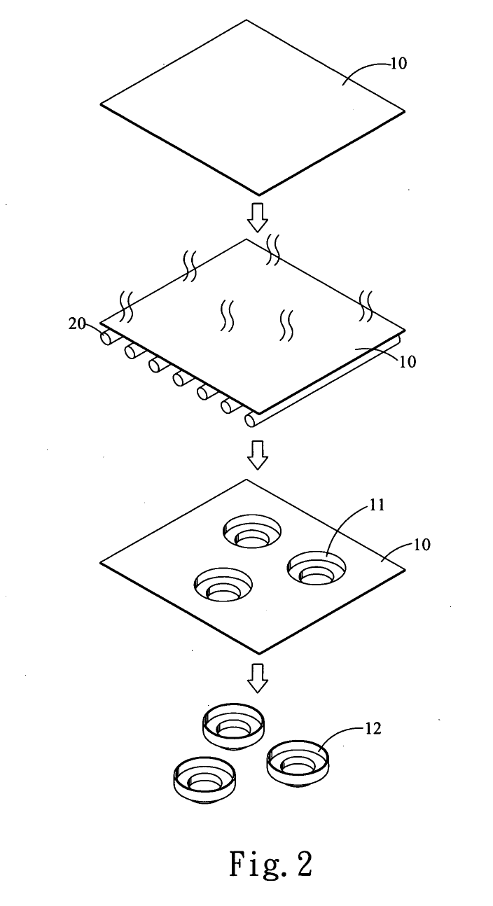

As shown in FIG. 1 and FIG. 2, a diagrammatic of a flow diagram and a schematic view of warm stretching processing for molding polylactic acid (PLA) containers are illustrated.

Manufacturing polylactic acid (PLA) containers includes steps as following:

Step 1, prefabricated PLA slips (10) or the like processed through a heater (20);

Step 2, a pre-heated mold (30) presses said initial warm stretching PLA slips (10) through high-pressure under near-vacuum conditions and heated to 100° C. or more, said slips (10) turned into a stretchable status, warm stretching proceeded to shape a parison (11); and

Step 3, trim off fringe ends (13), a high-temperature endurable finished container (12) is formed.

As a result, the finished container (12) is high-temperature endurable under a temperature shift from 100° C. to 130° C. In other words, a heat-resistance effect is achieved. Although the finished container (12) filled with hot water of temperature 100° C., it will not be out of shape.

Said heater (20) is operated under a temperature shift from 250° C. to 300° C. Since the same is originally heat-soften under a temperature shift from 60° C.˜80° C., being processed through higher temperature shift may facilitate next step of processing to achieve finished containers.

Said mold (30) is preheated under a temperature shift from 100° C.˜130° C. Said slips (10) is pressed and heated tip to a temperature of 100° C. or more under near vacuum conditions to warm stretch the slips to shape a parison (11).

Because a slim slip (10) processed through heated and pressed steps, a breadth of said slip (10) is conditioned in the range of 0.1 mm˜12 mm, preferably in the range of 0.3 mm˜2 mm. The latter is suitable for a finished container to show fashions.

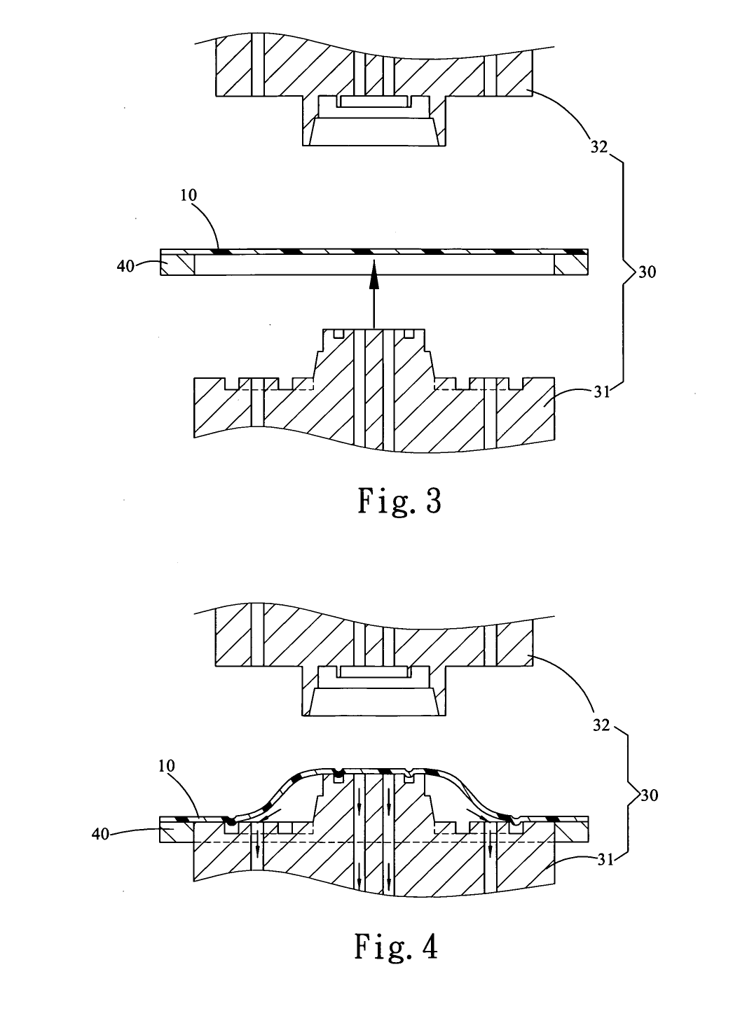

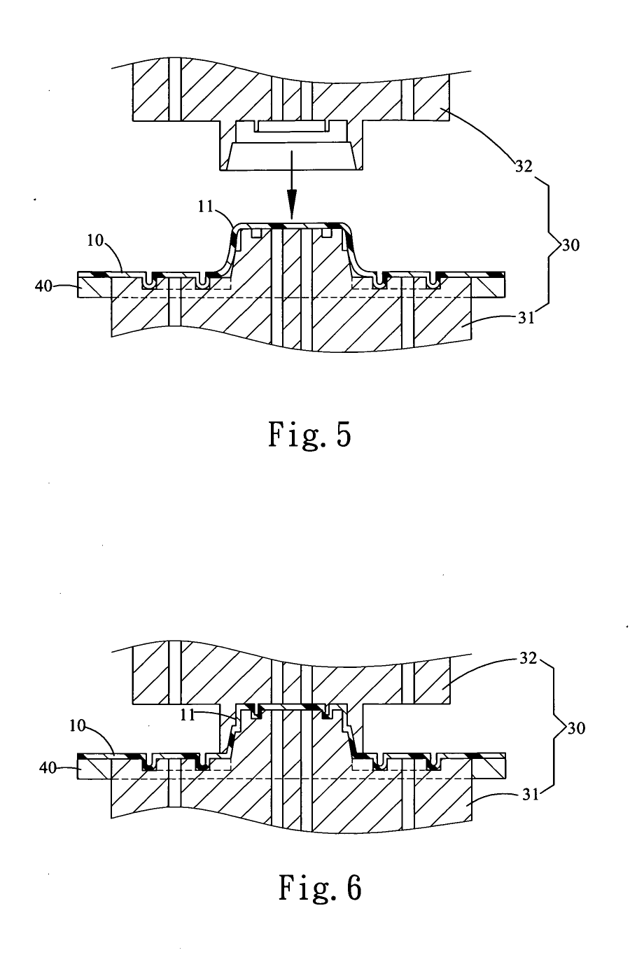

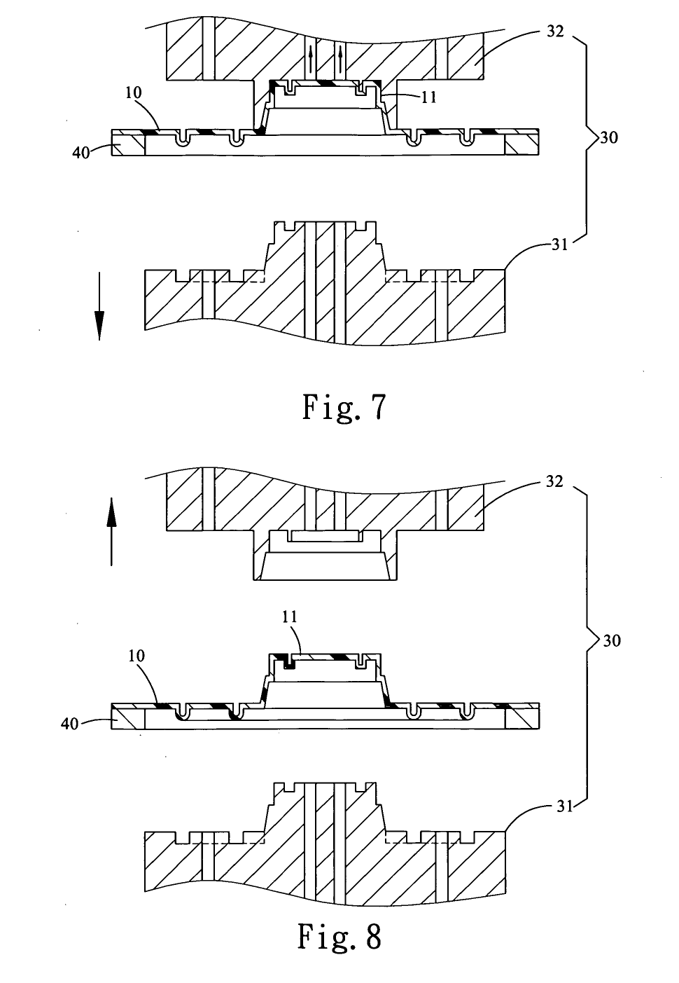

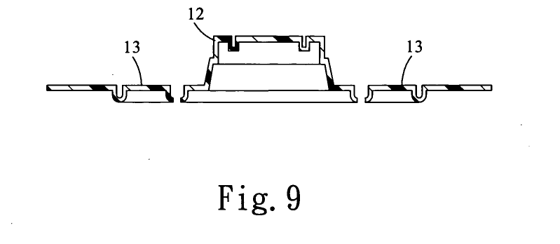

As shown in FIG. 3˜FIG. 9, schematic views of warm stretching processing for molding polylactic acid (PLA) containers heated and pressed under near vacuum conditions are illustrated.

In FIG. 3, the mold (30) is divided into a base portion (31), and a cover portion (32) correspondingly hung over the base portion (31); said slip (10) is processed between said base portion (31) and said cover portion (32). Said slip (10) is supported by a bracket (40). The slip (10) heated by a heater (20) (not shown) is to be heat-soften.

In FIG. 4, said slip (10) is placed over said base portion (31), upon suction of drawing-in air under near vacuum conditions, the slip (10) is substantially wrapped upon the base portion (31) and molded along the base portion (31).

In FIG. 5, said slip (10) sucked onto the base portion (31) under near vacuum conditions, the slip (10) is gradually shaped in the shape of a parison (11) on an upper surface of the base portion (31).

In FIG. 6, said cover portion (32) is activated to press over said base portion (31), most of the warm stretchable slip (10) is shaped into the parison (11), as the slip (10) is pressed and heated through the mold (30), i.e. between the cover portion (32) and the base portion (31).

In FIG. 7, said base portion (31) stops sucking in air, but said cover portion (32) starts sucking in air. Thereby, the cover portion (32) is detached from the base portion (31); the slip (10) is therefore sucked to the cover portion (32).

In FIG. 8, said cover portion (32) stops sucking in air to detach the slip (10) from adhering to the cover portion (32).

In FIG. 9, trim off fringe ends (13) about the parison (11) to form the container (12) is a high-temperature endurable and environmental friendly warm stretching finished product.

As above, although the mold (30) described in the present invention is configured by one base portion and one cover portion, but the mold (30) can also be realized by one base portion only, but the slip processed through heat treatments, the passage of time passed will be perceived as slow, protracted duration.

What is claim claimed:

1. A warm stretching processing for molding polylactic acid (PLA) containers comprising:
step 1, prefabricated PLA slips (10) or the like processed through a heater (20);
step 2, a pre-heated mold (30) presses said initial warm stretchable PLA slips (10) through high-pressure under near-vacuum conditions and heated to 100° C. or more, said slips (10): turned into stretched status, warm stretching proceeded to shape a parison (11); and
step 3, trim off fringe ends, a high-temperature endurable finished container (12) is formed.

2. The warm stretching processing for molding polylactic acid (PLA) containers of claim 1 wherein heat-softing the slips (10) of step 1 under a temperature shift from 60° C. to 80° C.

3. The warm stretching processing for molding polylactic acid (PLA) containers of claim 1 wherein the heater (20) of step 1 is operated preferably under a temperature shift from 250° C. to 300° C.

4. The warm stretching processing for molding polylactic acid (PLA) containers of claim 1 wherein the mold (30) of step 2 is preheated under a temperature shift from 100° C. to 130° C., preferably operated under a temperature of 120° C.

5. The warm stretching processing for molding polylactic acid (PLA) containers of claim 1 wherein a breadth of the slips (10) of step 1 is in the range of 0.1 mm˜12 mm.

6. The warm stretching processing for molding polylactic acid (PLA) containers of claim 5 wherein a breadth of the slips (10) of step 1 is preferably in the range of 0.3 mm˜2 mm.

7. A molding polylactic acid (PLA) container manufactured according to the warm stretching processing for molding of the same of claim 1 characterized in that: said container (12) is a polylactic acid container processed through high-temperature treatments.
